(19) United States
(12) Patent Application Publication
(10) Pub. No.: US 2022/0089424 A1
(43) Pub. Date: Mar. 24, 2022

(54) AUTOMATED BEVERAGE DISPENSING SYSTEM

(71) Applicants: Soykan Dirik, Laguna Niguel, CA (US); Mehmet Kaptana, Irvine, CA (US)

(72) Inventors: Soykan Dirik, Laguna Niguel, CA (US); Mehmet Kaptana, Irvine, CA (US)

(21) Appl. No.: 17/484,812

(22) Filed: Sep. 24, 2021

Related U.S. Application Data
(60) Provisional application No. 63/082,956, filed on Sep. 24, 2020.

(51) Int. Cl. B67D 1/08; G05B 15/02; G06Q 50/12; B65B 7/28

(52) U.S. Cl. CPC B67D 1/0888; G05B 15/02; B67D 1/0894; B65B 7/2842; G06Q 50/12

(57) ABSTRACT

The present invention discloses an automated beverage dispensing system that allows any beverage dispensing apparatus to be converted to a contactless, automated beverage dispensing apparatus.

### FIELD OF THE INVENTION

The present invention belongs to the field of beverage dispensing systems. More particularly the present invention relates to an automated beverage dispensing system that allows any beverage dispensing apparatus to be converted to a contact-less, automated beverage dispensing apparatus.

### BACKGROUND OF THE INVENTION

Beverages dispensing systems have been well-known for quite some time now. Broadly these beverage dispensing systems can be categorized in two categories—self-serve and crew-serve. At some point in all our lives we have encountered self-serve beverage dispensing systems in places like food courts of malls and fast food restaurants. Crew-serve beverage dispensing systems are located in the areas accessible only to the crew members of a restaurant and have features like pre-determined portion control for amount of beverage dispensed for a particular cup size. Commonly, restaurant employees may take an order, then manually pull a cup, may or may not add ice to the cup depending on the order, and then place the cup under the nozzle of a crewserve beverage dispensing system, which then dispenses a beverage to fill the cup as per the order at the press of a valve. Based on the type of the valve present in the beverage dispensing system, beverage is filled either manually, by the employee deciding on the amount of beverage to dispense, or automatically where the employee presses a cup-size button on the valve so that a predetermined amount of beverage is dispensed. Another popular method of automatically dispensing beverages is where an employee places the cup under the nozzle and the cup is filled to the top, and the valve stops dispensing beverage upon detecting overflow. Not only all of these methods are time consuming, wasteful and error-prone due to human involvement, increased hygiene awareness among customers requires a cleaner, preferably a contact-less beverage dispensing approach. There is therefore a need in the art for an automated beverage dispensing system that allows for correctly and speedily completing a beverage order in a contact-less manner.

### DESCRIPTION OF THE DRAWINGS

FIG. 1 is a perspective view showing an automation system mounted to a side of a beverage dispensing system, as per an embodiment of the present invention.

FIG. 2 is a perspective view showing a cup transferred to a fill handle component of the automation system, as per an embodiment of the present invention.

FIG. 3 is a perspective view showing movement of a cup in a fill handle to fill ice under the ice chute of the automation system, as per an embodiment of the present invention.

FIG. 4 is a perspective view showing movement of a cup in a fill handle of the fill handle component of the automation system to fill beverage under beverage valve as well as a second cup moving to a serving station, as per an embodiment of the present invention.

FIG. 5 is a perspective view showing an automation system capable of handling more than one cup at once, as per an embodiment of the present invention.

### DESCRIPTION OF THE INVENTION

The following description is presented to enable any person skilled in the art to make and use the invention, and is provided in the context of particular applications of the invention and their requirements. The present invention can be configured as follows:

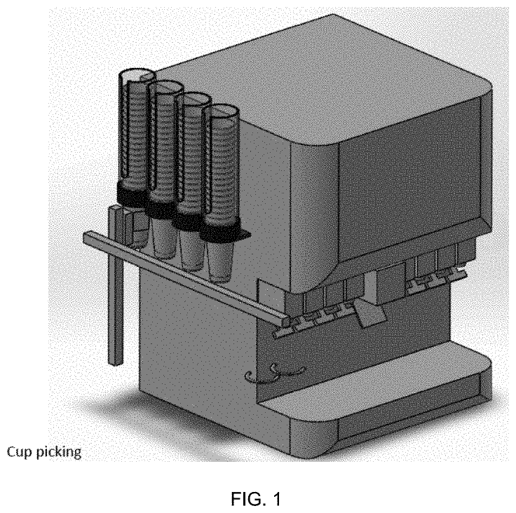

As illustrated in FIG. 1, as per an embodiment of the present invention an automation system is mounted on a beverage dispensing system. The automation system is connected to asn order system of a restaurant. The automation system can be connected to the order system using any of a wired connection or a wireless connection. The order system can be any of one managed by a crew member of a restaurant or a self-serve ordering system accessible to customers of a restaurant.

As per a preferred embodiment of the present invention the automation system comprises an order information receiving component which receives information from the order system about an order of beverages placed by a customer. The information comprises beverage details, ice requirements and cup sizes such as child, small, medium, large or extra-large cups. An order may comprise multiple beverages of different types, mixes of the beverage or flavoring (flavor shots), as well as different cup sizes for each beverage type.

The order may also mention the amount of ice for each of the beverages ordered.

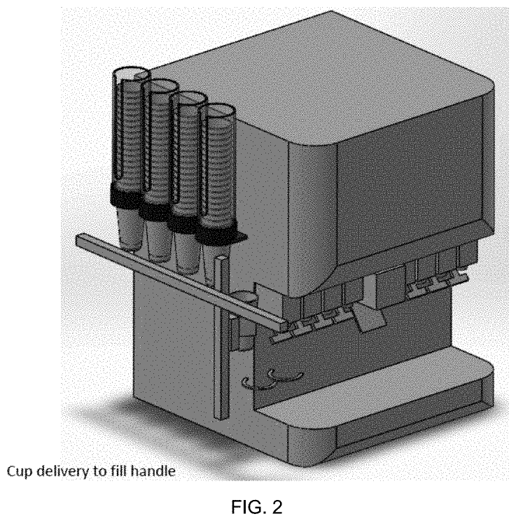

The automation system comprises an automated cup dispenser as shown in FIG. 1. The automated cup dispenser takes a cup from an array of cups, stacked in separate columns as per cup sizes, corresponding to one of the cup sizes in the order placed by a customer. Thereafter, the automated cup dispenser delivers the cup to a fill handle component of the automation system, as shown in FIG. 2, as per the preferred embodiment of the present invention. The fill handle component may comprise multiple fill handles as per an embodiment of the present invention, as shown in FIG. 2.

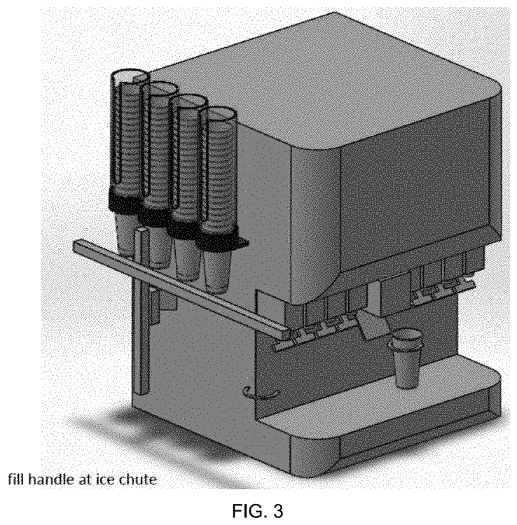

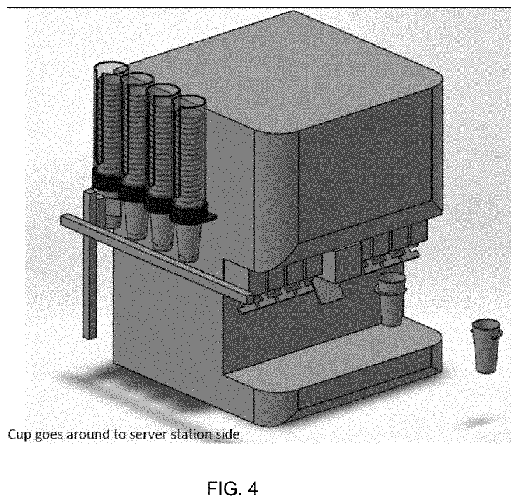

The cup delivered to the fill handle component is received in a fill handle which moves the cup further for the purpose of filling the cup with ice, if ordered, and then beverages. To achieve this, as shown in FIG. 3, the fill handle moves the cup under an ice chute of the beverage dispensing system. Once the cup has been filled with ice as per the order placed by the customer, the fill handle moves the cup under a beverage dispensing chute of the beverage dispensing system, as shown in FIG. 4. Once the cup has been filled with the beverage, the fill handle moves the cup to a sealing station.

The sealing station, upon receiving the cup, seals the cup in a sterilized plastic cover. The sterilized plastic cover ensures that the cup of beverage remains contact-less until the order is completed by delivering the cup of beverage to the customer.

After the cup is sealed in the sterilized plastic cover, the fill handle moves the cup to a serving station from where the cup can be collected by a customer or a crew member of the restaurant, as shown in FIG. 4.

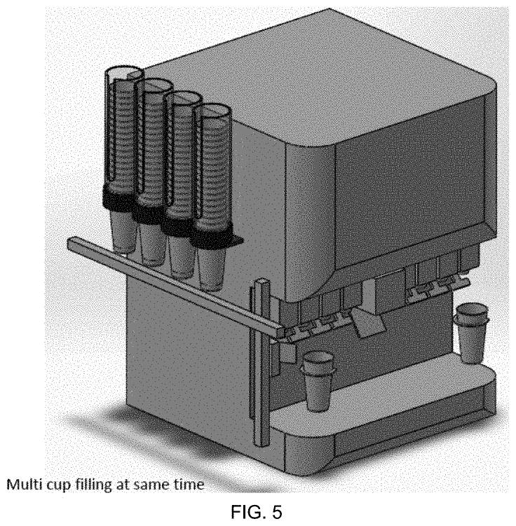

As show in FIG. 5, as per an embodiment of the present invention, the automation system can be enabled to dispense, move and fill multiple cups at the same time, where each cup could be of same or different size as well as each cup may have same or different beverage and ice requirements.

As per a preferred embodiment of the present invention, the automation system is detachable, and can be mounted to any existing beverage dispensing systems where the various components of the automation system can be removably attached to the required components of the existing beverage dispensing system and the existing order system of a restaurant. It can be easily understood and appreciated by any person skilled in the art that the automation system of the present invention can both be removably mounted to a new beverage dispensing system as well as can be made an integral part of a new beverage dispensing system. As per the this, any person skilled in the art would easily understand that the beverage dispensing system can be used on its own, without the automation system. Further, if needed, orders can be entered manually on an embedded screen on the automation system.

As per another embodiment of the present invention, the automation system may display one or more order details on an embedded screen. The order details being displayed may include, but not limited to, the type of the drink being prepared at a moment, number of drinks in an order, ice requirements, and cup size.

As per an embodiment of the present invention, the automation system can work in sync with the beverage dispensing system based on the order received, where the beverage dispensing system is equipped to dispense ice and beverages without any manual inputs.

As per another embodiment of the present invention, the automation system can work in sync with the beverage dispensing system based on the order received, where the beverage dispensing system is equipped to dispense ice and beverages only with manual inputs. In such a case the automation system would be capable of providing the manual inputs to the beverage dispensing system. In this particular case, any required manual inputs to dispense ice and/or beverages can be provided by the automation system.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of the present invention have been achieved by providing the above invention. Various modifications to the disclosed embodiments will be readily apparent to those skilled in the art and the general principles defined herein may be applied to other embodiments and applications without departing from the spirit and scope of the present invention.

Thus, the present invention is not intended to be limited to the embodiments shown, but is to be accorded the widest scope consistent with the principles and features disclosed herein. Therefore, the scope of the invention is to be determined by the terminology of the above description and the legal equivalents thereof.

What is claimed is:

1. An automated beverage dispensing system that allows a beverage dispensing apparatus to be converted to a contactless, automated beverage dispensing apparatus wherein:
a. the automation system is mounted on the beverage dispensing system,
b. the automation system is connected to the order system of the restaurant,
c. the automation system comprises an order information receiving component which receives information from the order system about the order of beverages placed by the customer, comprising beverage details, ice requirements and cup sizes,
d. automation system comprises an automated cup dispenser, a fill handle component and a sealing station.

2. The automated beverage dispensing system in claim 1 wherein the automated beverage dispensing system is detachable,
